(19) United States
(12) Patent Application Publication
(10) Pub. No.: US 2016/0070378 A1
(43) Pub. Date: Mar. 10, 2016

(54) DEVICE AND METHOD FOR AUDIBLE AND TACTILE INTERACTION BETWEEN OBJECTS

(71) Applicant: COMMISSARIAT A L'ENERGIE ATOMIQUE ET AUX ENERGIES ALTERNATIVES, Paris (FR)

(72) Inventors: Jean-Marc ALEXANDRE, Verrieres-le-Buisson (FR); Xavier APOLINARSKI, Antony (FR); Christian BOLZMACHER, Montrouge (FR)

(21) Appl. No.: 14/783,415

(22) PCT Filed: Apr. 9, 2014
(86) PCT No.: PCT/EP2014/057145

§ 371 Date: Oct. 8, 2015

(30) Foreign Application Priority Data
Apr. 10, 2013 (FR) 1353224

(51) Int. Cl. G06F 3/043; G06F 3/0488; G06F 3/01; H04R 17/00; H04W 4/00

(52) U.S. Cl. CPC G06F 3/043; H04R 17/00; H04W 4/008; G06F 3/016; G06F 3/0488; H04R 2420/07

(57) ABSTRACT

A device and a method for allowing a noncommunicating object to communicate comprises a processing module that provides a user interface that is capable of detecting an event on an area of the user interface, a control module for characterizing the detected event and a communication module for generating a message containing the characterization information from the detected event and receiving a digital message containing information for triggering an action that is associated with the event. The device also comprises piezoelectric means that are coupled to the processing module and capable of generating a mechanical vibration in the passive surface, which transforms the vibration into an acoustic wave in audio transmission mode, or of producing a mechanical vibration from an acoustic wave in audio reception mode.

### FIELD OF THE INVENTION

The invention concerns the field of interactive systems and the web of things and more particularly addresses the audio and tactile interaction between objects.

### PRIOR ART

The increasing communication demand engenders needs for connection and interaction between all types of systems, be they mobile, fixed, wired or wireless “WiFi”, active or passive. In particular, objects referred to as communicating or active such as personal computers PC, smartphones, cellphones, tablets or else tablets allow relay of information, interaction and very extensive and sophisticated data communication.

Conversely, everyday objects referred to as noncommunicating or passive such as furniture, decorative objects, for example, do not have the same capabilities of communication and interaction.

Nevertheless, there is a need to extend the audio and tactile interaction functions of communicating systems to everyday objects.

Cellphones or “PCs” that integrate personal information or general information have processing capabilities that would allow functions of everyday objects to be augmented if there were a communication link between them. However, to allow these everyday objects to communicate, it would be too expensive to integrate electronics as complex as those of a cellphone, for example, into each object.

There are approaches, such as wireless enclosures, wireless microphones or else telepresence systems. However, these solutions are limited to the execution of a single function, either audio or touch.

Other approaches propose man/machine interfaces to allow passive objects to communicate.

Thus, patent No. FR 2 825 882 A1 from Nikolovski proposes interactive glazing having microphone and loudspeaker functions that is based on the adaptation of a sheet to produce a device for transmitting acoustic waves in air by means of a piezoelectric transducer adhesively bonded to the sheet. One of the limitations of this system is that it cannot operate simultaneously in loudspeaker mode and microphone mode, that is to say that it cannot communicate in “Full Duplex” mode.

An improvement is presented in the patent FR 2 879 885 A1, still from Nikolov-ski, through the use of piezoelectric transducers on a sheet forming a man/machine interface that is machined in a special way. The invention likewise shows an operating solution for the sheet in high-fidelity loudspeaker mode having small dimensions.

However, there is not a complete solution that allows all or some of the functions of a communicating system to be extended to any noncommunicating object.

Moreover, there is not a solution that allows the creation of a communication network between noncommunicating objects.

The present invention meets this need.

### SUMMARY OF THE INVENTION

It is an object of the present invention to propose a hardware and software architecture that allows the interaction and communication capabilities of everyday objects to be increased by relocating all or some of the capabilities of systems referred to as communicating to each of said objects.

It is another object of the present invention to provide an intuitive and configurable system affording spatial extension of all or some of the functions of a cellphone, a PC or any other system equipped with a processor.

An advantage of the present invention is that it affords a highly integrated embodiment having low production cost by adding to noncommunicating objects a module moreover comprising piezoelectric elements, furthermore without impairing the primary use function of the objects.

The system addressed by the present invention is an integrated mechatronic and software device allowing an object or a more extensive system such as a house or a car to be transformed into an audio and tactile capture system and allowing remote control of these objects or systems via a cellphone or a PC.

Advantageously, the system of the invention affords new ‘mainstream’ applications of leisure, surveillance or else telepresence type by providing a vehicle or a residence with audio. The present invention allows access to new services, which are made possible by virtue of the noncommunicating objects being provided with audio.

The invention concerns a method for interacting between a communicating entity and at least one noncommunicating entity, the noncommunicating entity being equipped with an interaction device comprising piezoelectric means affixed to the surface of the noncommunicating entity and interaction means, the device being capable of performing the steps of:
identifying and locating the noncommunicating entity;
detecting an event on an area of the noncommunicating entity;
characterizing the detected event by means of parameters for characterizing the type of event;
generating a message containing the event characterization parameters and an identifier from the noncommunicating entity;
sending the message to the communicating entity;
receiving, as a response from the communicating entity, a digital message containing information for executing an action associated with said event;
converting the received message into an electrical signal;
generating an acoustic wave from the electrical signal; and executing said action.

Advantageously, an identification and location technology is used. In some embodiments, RFID technology or NFC technology is used.

Advantageously, the detection step involves detecting an event in a user interface area of the interaction device, in particular detecting a push or an impact on the functionalized surface or detecting a voice message.

Advantageously, the message sent to the communicating entity comprises a header providing information about the communication protocol between the interaction device and the communicating entity and a message body containing the characterization parameters.

Advantageously, the message received from the communicating entity comprises a header providing information about the communication protocol between the interaction device and the communicating entity and a message body containing information for triggering an action associated with said event. In a preferred implementation, the protocol is the Bluetooth or WiFi protocol.

Advantageously, the electrical signal from the conversion is amplified. Using the piezoelectric elements, it makes it possible to impart vibration to the noncommunicating structures or surfaces that will allow the transmitted vibration to be transformed into an acoustic wave.

In an implementation variant, the message generated by the communicating entity is sent to a plurality of noncommunicating entities.

Advantageously, the noncommunicating objects are chosen from the group of objects whose type is a wall, a door, a glass surface or other passive surface, or else spectacles. The communicating entity may be a cellphone.

The invention also concerns a system for interacting between a communicating entity and a plurality of noncommunicating entities, each noncommunicating entity being equipped with an interaction device comprising piezoelectric means affixed to the surface of the noncommunicating entity and interaction means, the interaction device being capable of performing the steps of the method as claimed in any one of the claims. The communicating entity comprises means for identifying the noncommunicating entity, classifying an event, generating a message for the execution of an action associated with the event and sending the message to the interaction device of the identified non-communicating entity. The communicating entity also comprises means for defining and configuring in a network the interaction devices of the plurality of noncommunicating entities.

The invention likewise concerns an interaction device for allowing a noncommunicating object to communicate, the device comprising:

a processing module having:
a user interface relocated to the passive surface of the noncommunicating object, which is capable of detecting an event on an area of said user interface;
a control module for characterizing the detected event; and
a communication module for generating a message containing the charac terization information from the detected event and an identifier from the non communicating object, and for receiving a digital message containing information for triggering on the noncommunicating object an action associated with said event;
   and

piezoelectric means affixed to the noncommunicating object and coupled to the processing module, which are capable of generating a mechanical vibration in the surface, which transforms said vibration into an acoustic wave in audio transmission mode, or of producing a mechanical vibration from an acoustic wave in audio reception mode.

### DESCRIPTION OF THE FIGURES

Various aspects and advantages of the invention will emerge with the support of the description of a preferred but nonlimiting mode of implementation of the invention with reference to the figures below, in which:

FIG. 1 shows an overview of the architecture of the system of the invention;

FIG. 2 shows a first implementation of the interaction device of the invention;

FIG. 3 shows a variant of the interaction device of the invention;

FIG. 4 shows a sequence of the main steps in the interaction between objects according to the principle of the invention.

### DETAILED DESCRIPTION OF THE INVENTION

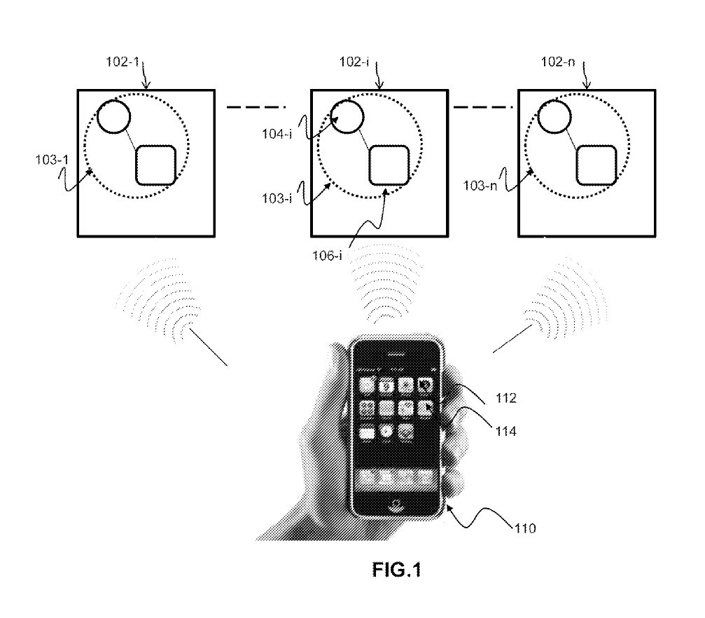

FIG. 1 shows a general architecture for the system of the invention comprising a plurality of noncommunicating objects (102-1 to 102-n) and at least one communicating object (110). The noncommunicating objects may be disposed in the same place, such as a closed interior like a house or a car. By way of example, these noncommunicating objects may be a wall, a door, a glass surface, but also devices worn near the body like spectacles or any other passive surface allowing an interaction module (103-1 to 103-n) to be affixed or coupled thereto. It should be noted that the principle that is described can apply to a single noncommunicating object.

Each noncommunicating entity (102-i) is equipped with an interaction device (103-i) that will perform an interaction with the communicating entity (110) according to the principle of the invention.

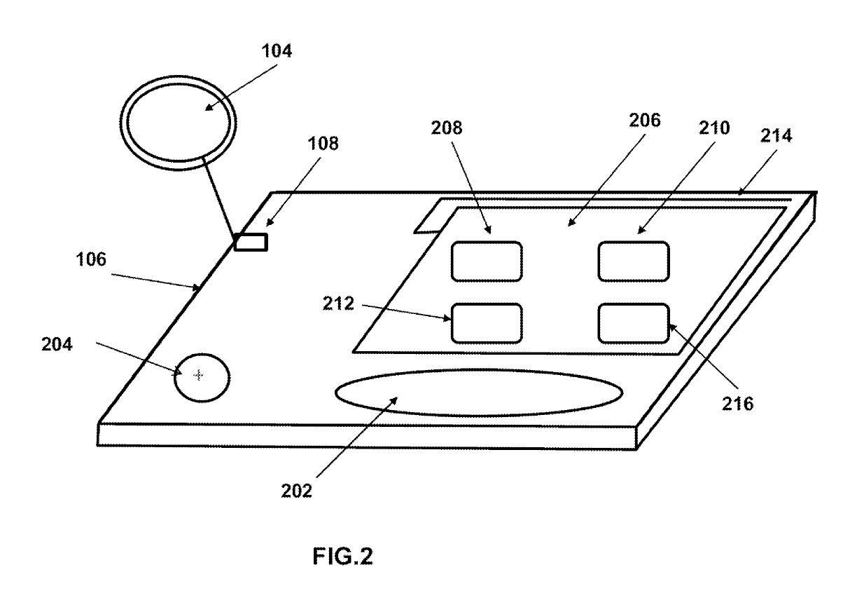

The interaction device (103-i) generally comprises two operatively coupled modules (104-i, 106-i) that are described in more detail with reference to FIG. 2.

In the example shown, the noncommunicating objects will use the interaction device to set up a communication with the communicating entity (110). The identification, location and communication of the noncommunicating objects can equally rely on protocols such as RFID, NFC, GSM, Bluetooth, WiFi or any other wireless protocol allowing data transfer. As a variant, a noncommunicating object will be able to be equipped with an interaction module in order to set up a wired communication with the communicating entity.

The communicating entity (110) may be a remote or local, fixed or mobile device of cellphone, personal computer or smartphone type or more generally any device having circuits for processing the information in data transmission mode and reception mode.

The communicating entity besides standard circuits allowing the information to be processed comprises a configuration module (112) and an application module (114).

The configuration module (112) comprises means for defining, configuring and identifying each interaction device (103-i) that provides an object on which it is positioned with a function. Moreover, the configuration module comprises means for defining and configuring in a network a plurality of interaction devices.

The application module (114) is coupled to the configuration module and comprises means for exchange with the existing applications of the communicating entity in order to obtain and retrieve general and/or personal data that are characteristic of the holder of the communicating entity.

Thus, the configuration and application modules allow management of a whole set of interaction devices and creation of application services by virtue of data that are either general, of weather forecast, web, etc., type, or personal, of schedule, music, etc., type.

FIG. 2 shows a first implementation of the interaction device (103) that is intended to be affixed to a noncommunicating object in order to provide it with a function. The device comprises a sound module (104) that is coupled to a processing module (106) that allows a detected event to be classified and transmitted to the communicating entity. The sound module is preferably made up of one or more piezoelectric chips connected to the processing module by an electrical wire and an electrical connector (108).

The processing module (106) comprises a user interface (202), a power source (204) and an electronic unit (206).

The user interface (202) consists of a touch area around the interaction module that allows an event to be initiated by pressure or impact in the area. The interface may also comprise a standard microphone or use the surface provided for the function as an acoustic antenna using the piezoelectric chip to receive an audible signal from the user. The voice command is transferred to the communicating entity and processed on the latter.

The power source (204) provides the supply of electric power to the interaction module and can come either from a rechargeable battery, from cells or from an external source (220 V-50 Hz power supply, battery or external cell, photovoltaic cell, etc.).

The electronic unit (206) comprises a communication module (208), a control module (210), an audio amplifier (212), an antenna (214) and a power supply (216).

The communication module (208) is coupled to the control module and conducts the communication via a radiocommunication link that will transmit or receive a signal. The communication link may be a link of WiFi or Bluetooth type.

The control module (210) incorporates a processing unit, a memory module and a digital input/output management module. A low-consumption microcontroller can alternatively provide all of these functions.

The audio amplifier (212) allows the acoustic wave that is transmitted from the sound module to be amplified. The audio amplifier comprises at least one amplifier stage, a filter stage of low-pass type, a high-voltage amplifier stage for supplying power to the piezoelectric chip.

The antenna (214) allows electromagnetic waves to be captured or radiated. It is a device for transforming an electrical signal in a conductor into an electromagnetic signal in space. Its size and geometry are suited to the frequency band to be transmitted.

The processing module (106) may have means for hanging (not shown) on the object to to be provided with a function, of adhesive or self-gripping tape type, for example. In an implementation variant, the hanging means allow the battery to be re-charged on an appropriate docking station.

The user interface (202) may also be equipped with an alphanumeric display screen.

The piezoelectric chip(s) of the sound module (104) are affixed to the object that is to be provided with a function. They may be adhesively bonded or attached mechanically. The piezoelectric chip(s) are connected to the audio amplifier (212) of the electronic unit. During operation, each piezoelectric element will generate or impress a mechanical vibration in the rigid element or passive surface on which it is placed and this surface will transform this mechanical vibration to an acoustic wave (audio transmission mode) or conversely produce a mechanical vibration from an acoustic wave (audio reception mode).

The piezoelectric chips typically have a thickness of between 0.1 mm and 1 mm with a rectangular or circular geometry. Their size may vary between 1 mm and 50 mm according to the surface to be provided with a function.

Thus, the sound module (104) constitutes a set of loudspeaker, microphone and vibration or impact capture functions, said vibration or impact being able to be generated by the nail of a finger acting as a “click” function, for example.

In a preferred implementation, the processing module (106) can be a housing with sides of between 5 and 10 cm and with a thickness in the order of 5 mm.

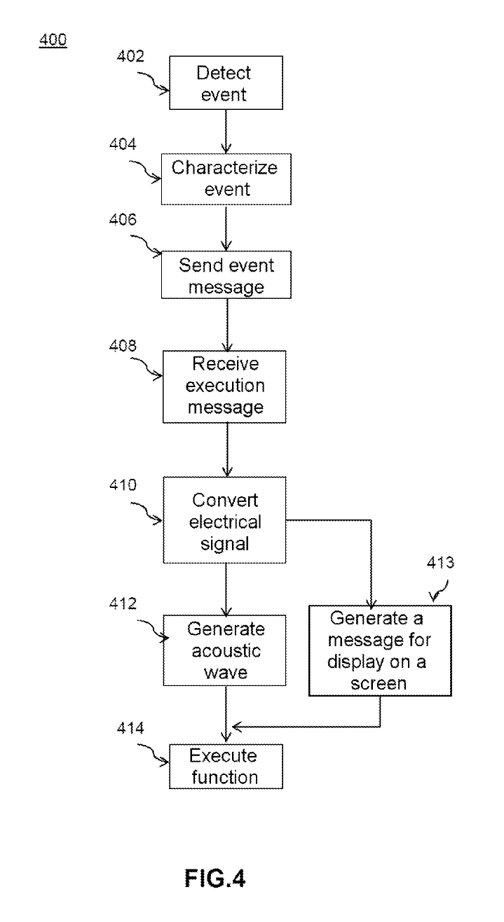

The implementation in which the user interface comprises buttons is particularly suited to use on a communicating door. Thus, it becomes possible to detect that a person has knocked on the door. The piezoelectric chip transforms the impact on the door into an electrical signal that can be sent to the communicating entity. Following processing on the communicating entity, a signal is transmitted to the noncommunicating entity. This signal is provided, following amplification, for the piezoelectric chip. The piezoelectric chip then imparts vibration to the door, and a sound can be relayed to the person. The interaction with the communicating object allows the personalized information to be relayed, for example a piece of information about the presence of the visited person to be provided from the content of his electronic schedule retrieved by the communication module. The operating principle is explained in detail later with reference to FIG. 4.

An advantage of the system of the invention is that it firstly allows the bell button and the bell for a door to be replaced by a single integrated object and it secondly allows contextualized and personalized messages to be relayed. This is because the configuration/management module integrated in the communicating entity allows the message for transmission to be defined according to the time and the context. In the example of the front door, several options may be envisaged:
“Doorbell mode” with a melody or a voice message relayed for the visitor. The melody or the message can be programmed according to the time (or according to other parameters if the communicating entity is not connected) or in relation to the weather forecast by setting up a relationship with a weather forecast application installed on the communicating entity.
“User information mode” for relaying contextualized information for the user. On detection of the opening of the door, an audio message is relayed, for example allowing indication of the tasks in a schedule that is to be performed. The tasks are retrieved via the communication module from the “To Do” list in the schedule of the user that is available on the communicating entity.
“Visitor information mode”, which allows the user to define the message to be relayed to the visitor according to user parameters, such as his timetable. The message may be information about a meeting place, for example.

Thus, such a system can be used in the tertiary sector for spaces in high demand such as a doctor's practice and for which it then becomes possible to relay detailed messages at the front door, such as “Waiting room at the back on the left, Doctor Durant will be 15 minutes late.”

Equally, messages relaying shop opening times, indicating the door of the office of someone or else, for a teenager's bedroom door, a spoken message that is suited to his humor or sounds of cellphone ring type.

Such functions are not provided by a conventional doorbell. Moreover, the implementation of the system of the invention is more compact than a conventional doorbell.

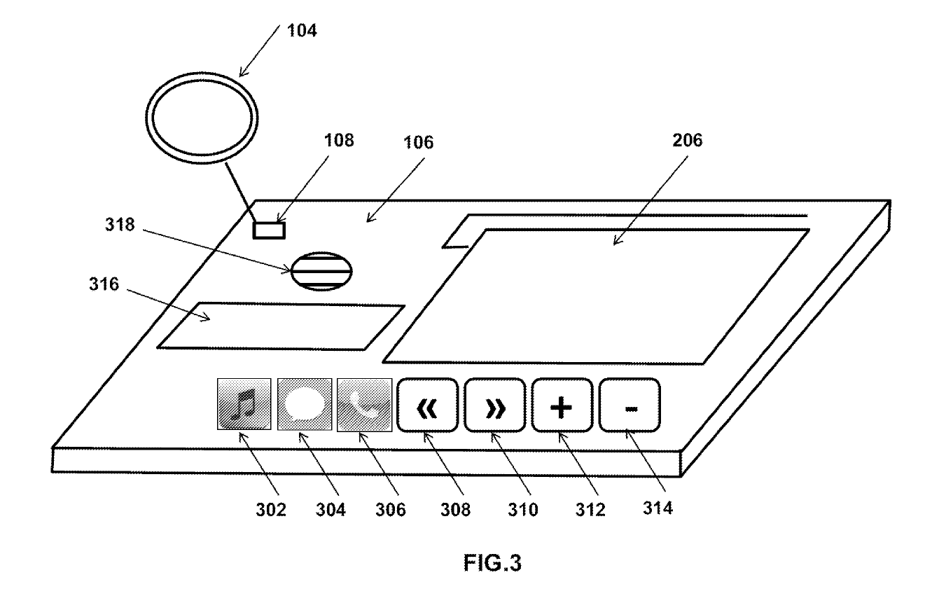

The device of FIG. 3 comprises a sound module (104) coupled to a processing module (106). The implementation of FIG. 3 presents an implementation variant for the interaction device of the invention, which variant is particularly suited to use on a glass surface. The elements that are identical to those of FIG. 2 are not described again. In this version of the device, the user interface is composed of the piezoelectric chips that provide the passive surface with a function in order to detect a pressure variation, an impact or speech. A touch language allows the different functions to be changed, such as starting music, reading a “Short Message Service (SMS)”, changing the volume of the music. By way of example, an impact in a precise spot allows the music mode to be selected (302), and two impacts change over to SMS mode (304). Another spot can be used to change the volume (312, 314), read the next SMS, change the title, etc.

During operation, the sound module (104) and the processing module (106) are disposed on the glass surface. A user can select one of the proposed applications by pressing, touching or impacting the surface. If he chooses the music function, reading of the content of the music library available on the communicating entity is proposed and displayed on the alphanumeric screen (316). An impact at a precise spot or pressure exerted on the passive surface allows the piece to be chosen or allows the audio level in the room to be regulated.

In another mode of operation, when a call is received on the communicating entity, the window transmits the sound of the ring of the telephone. By tapping on the window, it is possible to take the call.

In an extended version, the modules can be configured and networked on the same communicating entity. Thus, in a residence, if a user changes rooms, it is possible to provide the hands-free function by pushing the surface that has been provided with the function in the new room.

In another mode of operation, when an SMS message is received, the window “transmits” an “SMS” sound corresponding to the sound of the communicating entity. By tapping on the passive surface, either the alphanumeric screen displays the SMS or the electromechanical conversion system allows the sound delivered to correspond to the reading of the message. A specific touch language can be programmed to know the previous and next messages.

Similarly, other programming can be implemented, such as display of the time on the screen (316) or in voice mode.

According to the same principle, from the configuration module implemented on the communicating entity it is possible to configure each interaction module installed on a noncommunicating object and to reproduce all or some of the applications of a cellphone in all of the rooms of a house, moreover while having a highly integrated and low-cost system.

An advantage of the present invention is allowing multiuser use, for example by positioning interaction modules on the windows of each of the rooms of a house, and configuring each module in relation to a communicating entity.

In another use, the present invention allows a kitchen worktop to be made interactive. By having at least one piezoelectric chip on the worktop, which chip is connected to an interaction module, which is itself able to communicate with a personal computer as communicating entity, the piezoelectric chip provides the worktop with audio, and the steps of a recipe can be spoken. If the interaction module has a microphone, the user can use the words “next” or “previous” to ask the system to relay the message from the next step.

In an advanced configuration, the user can speak keywords such as “cooking time” or “temperature” in order to obtain complementary information. The system can be enhanced by the addition of a low-profile LCD miniscreen that relays an image in each key step.

A person skilled in the art will appreciate that only a few uses are presented but that these become unlimited through the application of the same principles of the present invention as are described now with reference to FIG. 4.

FIG. 4 shows a sequence for the main steps (400) of the implementation of the interaction between a communicating entity and a noncommunicating object. A communicating entity of cellphone type, for example, identifies and locates the non-communicating entity(ies) from a wireless network of (WiFi, Bluetooth, etc.) type.

The method starts in step (402) by detecting an event on a user interface area of an interaction module on a noncommunicating entity. The event may be a touch, a pressure and an impact exerted on this normally passive surface or a voice message captured by this surface using piezoelectric chips or electromechanical converters. The detected event may likewise be pressure on a button, a voice message toward a microphone, a soundwave transmitted by the person wishing to interact with the system or a message received on a digital screen.

In a next step (404), the method allows the event to be characterized by identifiers of event type (impact, touch, pressure, voice message, etc.) and identifiers from the interaction module. The device, which may be a patch adhesively bonded to a door, detects impacts without specific logic. The entrance event may be one or more impacts at different force and duration. The electronics onboard the patch filter and classify this information.

The next step (406) involves generating a message that contains the identification parameters and sending the message to the communicating entity. This message is divided into two fields. A header contains information about the communication protocol and a message body that contains the information for transmission. The information for transmission is a prerecorded command of “change music” or “someone has knocked on the door” type. Alternatively, this may be a voice message that will be processed by the communicating unit. In a preferred implementation, the communication protocols are Bluetooth or WiFi technology.

The next step executed by the communicating entity involves classifying the event and generating another message that contains an action associated with the type of event. The communicating entity selects the noncommunicating entity(ies) concerned according to the event and transmits the message to it/them.

In a subsequent step (408), a message containing information for the execution of an action associated with the detected event is received by the noncommunicating entity. This message is divided into two fields: a header that contains the information about the communication protocol and a message body that contains the information for transmission. In response from the central unit, the message contains the type of message to be transmitted from the noncommunicating entity, for example a voice message about the weather forecast, or announcing receipt of a text, or else the sending of a music track to be played.

The next step (410) involves converting the digital data of the received mes-sage into an electrical signal, and amplifying the signal. The electrical signal makes it possible to impart vibration to the piezoelectric elements coupled to the interaction module and to generate (412) an acoustic wave by transforming the vibration.

In a next step (414), the corresponding function is executed via the passive surface of the noncommunicating object.

This procedure can be repeated continuously when a new event is detected. Advantageously, the position of the communicating entity can be used to adapt a functionality such as reproduction of the music. If the user moves, another, closer, noncommunicating entity is activated to reproduce the music.

Thus, as described previously, use functions that can be relocated to non-communicating objects may be:

multiuser hands-free telephone;

reading of messages and sms;

providing rooms with audio, relaying music;

reading weather forecasts, reading market data, reading memo pads, etc.

A person skilled in the art will appreciate that it is possible to extend the principles described for new applications, such as:

audio effect spatialized throughout a house;

telepresence;

cancellation or attenuation of an external sound through relay of an audio signal that is the inverse of the external sound.

Advantageously, the message from step (406) that is received by the communicating entity contains the information relating to the event, the requested data and the identity of the noncommunicating entity that needs to be provided with a function. On reception, the communicating entity assembles the required data that may be available in memory as a music library or a prerecorded message or retrieves data from Internet sites or else from a schedule. The data are then grouped and sent in a return message to the interaction module.

In a multiuser implementation or a network implementation, the content and the units in receipt of the message are dependent on the information to be transmitted. A message to provide information that a person is knocking on the front door can be transmitted to all users. Alternatively, one communicating unit can be chosen by the user using a button to trigger an action.

A person skilled in the art will appreciate that variations can be made to the method as described in a preferred manner while maintaining the principles of the invention.

The present invention can be implemented on the basis of hardware and/or software elements. It can be available as a computer program product on a computer-readable medium. The medium may be electronic, magnetic, optical, electromagnetic or may be a relay medium of infrared type. Examples of such media are semiconductor memories (Random Access Memory RAM, Read-Only Memory ROM), tapes, floppy disks or magnetic or optical disks (Compact Disc-Read Only Memory (CD-ROM), Compact Disc-Read/Write (CD-R/W) and DVD).

Thus, the present description illustrates a preferred implementation of the invention but is not limiting. An example has been chosen to allow a good understanding of the principles of the invention, and a specific application, but it is in no way exhaustive and must allow a person skilled in the art to make modifications and provide implementation variants while preserving the same principles.

1. A method for interacting between a communicating entity and at least one noncommunicating entity, the noncommunicating entity being equipped with an interaction device comprising piezoelectric means affixed to the surface of the noncommunicating entity and interaction means, the device being capable of performing the steps of:
identifying and locating the noncommunicating entity;
detecting an event on an area of the noncommunicating entity;
characterizing the detected event by means of parameters for characterizing the type of event;
generating a message containing the event characterization parameters and an identifier from the noncommunicating entity;
sending the message to the communicating entity;
receiving, as a response from the communicating entity, a digital message containing information for executing an action associated with said event;
converting the received message into an electrical signal;
generating an acoustic wave from the electrical signal; and
executing said action.

2. The method as claimed in claim 1, in which the detection step involves detecting an event in a user interface area of the interaction device.

3. The method as claimed in claim 1, in which the detection step involves detecting a push or an impact on the passive surface or on a button.

4. The method as claimed in claim 1, in which the detection step involves detecting a voice message.

5. The method as claimed in claim 1, in which the message sent comprises a header providing information about the communication protocol between the interaction device and the communicating entity and a message body containing the characterization parameters.

6. The method as claimed in claim 1, in which the received message comprises a header providing information about the communication protocol between the interaction device and the communicating entity and a message body containing information for triggering an action associated with said event.

7. The method as claimed in claim 5, in which the communication protocol is based on the RFID, NFC, Bluetooth or WiFi protocol.

8. The method as claimed in claim 1, in which the conversion step moreover comprises a step of amplification of the generated electrical signal.

9. The method as claimed in claim 1, in which the step of generation of an acoustic wave involves providing the electrical signal for the piezoelectric means in order to impart vibration to the surface of the noncommunicating entity and transforming the vibration into an acoustic wave.

10. The method as claimed in claim 1, in which the step of reception of an execution message involves receiving the message on a plurality of noncommunicating entities.

11. The method as claimed in claim 1, in which the noncommunicating objects are chosen from the group of objects whose type is a wall, a door, spectacles, a glass surface or any other passive surface.

12. The method as claimed in claim 1, in which the communicating entity is a cellphone.

13. A system for interacting between a communicating entity and a plurality of noncommunicating entities, each noncommunicating entity being equipped with an interaction device comprising piezoelectric means affixed to the surface of the noncommunicating entity and interaction means, the interaction device being capable of performing the steps of the method as claimed in claim 1, the communicating entity comprising means for identifying the noncommunicating entity, classifying an event, generating a message for the execution of an action associated with the event and sending the message to the interaction device of the identified noncommunicating entity.

14. An interaction device for allowing a noncommunicating object to communicate, the device comprising:
a processing module having:
a user interface relocated to the passive surface of the noncommunicating object, which is capable of detecting an event on an area of said user interface;
a control module for characterizing the detected event; and
a communication module for generating a message containing the characterization information from the detected event and an identifier from the noncommunicating object, and for receiving a digital message containing information for triggering on the noncommunicating object an action associated with said event;
and
piezoelectric means affixed to the noncommunicating object and coupled to the processing module, which are capable of generating a mechanical vibration in the surface, which transforms said vibration into an acoustic wave in audio transmission mode, or of producing a mechanical vibration from an acoustic wave in audio reception mode.
